(19) United States
(12) Patent Application Publication
(10) Pub. No.: US 2008/0222399 A1
(43) Pub. Date: Sep. 11, 2008

(54) METHOD FOR THE HANDLING OF MODE-SETTING INSTRUCTIONS IN A MULTITHREADED COMPUTING ENVIRONMENT

(75) Inventor: Philip G. Emma, Danbury, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/682,028

(22) Filed: Mar. 5, 2007

(51) Int. Cl. G06F 9/00

(52) U.S. Cl. 712/223

(57) ABSTRACT

The present invention relates to the provisioning of mode-setting instruction as they relate to requisite hardware within a processing system. As such, the processing system allows for multiple programs, or processing threads of execution, to independently specify Modes, wherein modes are program specified assertions in regard to the processing system hardware environment (e.g., the temperature, voltage, frequency, gating functions, etc.). Thus, the objectives of the present invention are to facilitate a mutually acceptable environment for all of the processing threads that are being executed within a processing system; this objecting being subject to the respective processing requirements as requested by Mode-setting instructions that are specified by each executed processing thread.

### BACKGROUND OF THE INVENTION

1. Field of the Invention

This invention relates to the setting of modes in a multithreaded processor on which independent code threads are concurrently executed, and particularly to the dynamic reconciliation of requested modes that have been specified by the set mode instructions of multiple threads as they are dynamically executed together, and as the multiple threads are subjected to the exogenous environment of an simultaneous multithreading machine.

2. Description of Background

Before our invention, traditionally, the trend in microarchitecture had been to strive for more Instruction Level Parallelism (ILP) to improve the performance of a single program (also referred to as a thread). Accomplishing this objective required the adding of more hardware to a processor, both in the replicating of various functions (so that multiple instructions could be processed simultaneously) and in managing the larger and more complex aggregation.

At the turn of the century, it became clear that power supply issues were placing limitations on the hardware elements that could be put on a chip. As a result, there was a slight backlash against the implementation of overly complex microarchitectures, since the added circuitry usually burned power at a higher rate than it increased performance. Circuit designers began to work much harder at reducing the power consumption of circuits, and microarchitects started implementing active power management procedures.

Generally, active power management involves ascertaining what particular hardware features may be of use during a period of time. Further, active power management involves temporarily throttling back the power that is supplied to specified circuit hardware features so as to conserve power without sacrificing much performance or to conserve power when it is known that higher performance is not needed.

There are numerous situations wherein the throttling back of power supply may be necessitated. For example, a voltage can be stepped down and the frequency reduced within a circuit in the event that ultra high performance is not necessary. Further, in the event that a program does not need to perform specific functions, then the hardware that is associated with the function can be temporarily deactivated. For example, in the event that a program is not required to perform any floating-point calculations, then the floating-point unit(s) can be deactivated.

In some of the early procedures for implementing active power management hardware systems were configured to monitor themselves to make the appropriate determination in regard to power management. The advantage of performing this function in hardware is that it does not require adding new instructions to the Instruction Set Architecture (ISA). In existing ISAs, power consumption levels are not visible to the programmer, thus the software it is not configured to implement energy conservation protocols.

As mentioned above, it has become substantially clear that power is a precious on-chip resource; as such, software must evolve to aid in power management operations. There are many operations that can be performed better in software, due in part to software applications usually having knowledge of what hardware it will utilize and how it will utilize the hardware, while the hardware can only make approximations for hardware usage operations. For example, an operating system knows when it is idle, or when it is dispatching a low-priority task. Therefore, the operating system can choose to throttle back the voltage and the frequency within a hardware system. The compiler knows what resources will be used, and when the program that it compiles will use them. Thus, the computer could easily append a prologue to the compiled module to turn various hardware elements off, and to make certain that other are on (since they could have been turned off by a previous program).

For software to be able to explicitly activate or deactivate a hardware feature, an instruction is needed in the ISA that can manipulate the controls (on and off switches) accordingly. Currently, a “Set Mode” (SM) instruction has been proposed as such an instruction to perform the operation of manipulating the activation and deactivation of hardware elements. The semantics for the SM instruction are ({<opcode>, <mode>}, wherein the <opcode> field specifies that it is a SM instruction, and the <mode> field specifies in some way what hardware element is to be turned on or off.

It must be noted that <mode> could be a literal bit-vector of the physical control points (on and off switches), or it could specify a method for constructing the vector (e.g., fetch it from memory, or perform a logical operation upon particular registers). Additionally, since different processors and chips may have slightly different controls, the bit vectors would accordingly be configured for those differing processors and chips. Therefore, if the bit vectors are different for different machines, the software (i.e., compilers, loaders, etc) must use the appropriate bit vectors when compiling or loading code for each particular machine.

Another development that emerged in microarchitecture following the rise of ILP techniques was hat of simultaneous multithreading (SMT). Microarchitectures designed for high ILP contain numerous resources that take advantage of inherent parallelism when it exists; many of those resources sit idle during much of the execution when the parallelism is not provided. SMT emerged to take advantage of all of the idle resources found in such machines to increase the utilization performance of the machines.

In an SMT machine, there are multiple programs (or “threads”) being executed at the same time. In modern machines, this is typically a fixed amount of threads (e.g., two (2) or four (4) threads). A 4-way multithreaded machine will hold the state for 4 independent programs. For each thread, this state includes the program counter (which points to the instruction being executed) and the working registers used by the program. The processor decodes and executes instructions from all four (4) threads simultaneously in such a manner that the instructions from those threads simultaneously share the hardware.

ISAs that include “Set Mode” (SM) instructions present a particular problem in regard to program threads containing these instructions in the event that a machine is also a multithreaded machine. In particular, while a compiler will know how to set up the hardware elements for any thread that it compiles, the compiler cannot known what elements will be required by other unrelated threads with which the compiled thread will be dynamically scheduled to run. That is, the compiler cannot have a-priori knowledge of the other activity and modes that will be required when the compiled thread actually runs. Further, the compiler cannot know the states of dynamically varying environmental parameters (such as ambient temperature, inductive noise, etc.) that will pervade at the time that the thread will eventually run.

Therefore, there exist a need for a methodology to dynamically reconcile requested modes that have explicitly specified by the SM instructions of multiple threads as they are dynamically executed together, and as they are subjected to the exogenous environment of an SMT machine.

### SUMMARY OF THE INVENTION

The shortcomings of the prior art are overcome and additional advantages are provided through the provision of a method for supporting simultaneous multithreading within a computing environment, wherein the method further comprises the steps of identifying at least two programs, wherein the programs are executed as respective processing threads, generating a Set Mode instruction, the Set Mode instruction being configured to be executed within at least one processing thread, the Set Mode instruction further comprising a mode field, the mode field identifying at least one system resource that is configured to be activated or deactivated.

The step of generating a Set Mode instruction further comprises the steps of generating a Set Mode instruction, wherein the mode field of the Set Mode is set to ON in the event that a compiler logic mechanism determines that this action is required by an executing code segment in regard to the system resource that is associated with the mode field, and setting the mode field of the Set Mode to Off in the event that the compiler logic mechanism determines that there is no action required by the executing code segment in regard to the system resource that is associated with the mode field. The method further comprises the step of transmitting a control signal to activate or deactivate the at least one system resource, the control signal being based on a logical combination of mode fields that are set by Set Mode instructions comprised within the programs that are executed as respective processing threads.

Further aspects of the present invention comprise a method for supporting simultaneous multithreading within a computing environment, wherein the method further comprises the steps of identifying at least two programs, wherein the programs are executed as respective processing threads, generating a Set Mode instruction, the Set Mode instruction comprising a mode field, the mode field identifying at least one system resource that is capable of being activated or deactivated, the Set Mode instruction being further configured to comprise a Set Mode On (SMON) instruction or a Set Mode Off (SMOFF) instruction that is executable within each respective processing thread.

The step of generating a Set Mode instruction further comprising the steps of generating SMON and SMOFF instructions, the step of generating SMON and SMOFF instructions further comprising the steps of generating a SMON instruction setting a first mode field to On in the event that a compiler logic mechanism determines a positive requirement is required by an executing code segment in regard to the system resource that is associated with the first mode field, and setting the first mode field to Off in the event that the compiler logic mechanism determines that no positive requirement is required by the executing code segment in regard to the system resource that is associated with the field mode field.

Further, the method comprises the step of and generating a SMOFF instruction setting a second mode field On in the event that the compiler logic mechanism determines that no positive requirement is required by the executing code segment in regard to the system resource that is associated with the second mode field, and setting the second mode field Off in the event that the compiler logic mechanism determines a positive requirement is required by the executing code segment in regard to the system resource that is associated with the second mode field. Lastly, a control signal is transmitted to activate or deactivate the at least one of system resource based on a logical combination of mode fields set by SMON and SMOFF instructions within programs executing within the respective processing threads.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a circuit that can be implemented within aspects of the present invention.

FIG. 2 illustrates one example of a circuit that can be implemented within aspects of the present invention, wherein SMOFF and SMON instructions are utilized.

FIG. 3 illustrates one example of a decoder circuit that can be implemented within aspects of the present invention.

FIG. 4 illustrates one example of a circuit that can be implemented within aspects of the present invention wherein a time-delay feature is implemented.

FIG. 5 illustrates one example of a flow diagram detailing operational flows for conditional mode vectors that can be implemented within aspects of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Within aspects of the present invention embodiments are presented relating to the provisioning of mode-setting instruction as they relate to requisite hardware within a processing system. As such, the processing system allows for multiple programs, or processing threads of execution, to independently specify Modes, wherein modes are program specified assertions in regard to the processing system hardware environment (e.g., the temperature, voltage, frequency, gating functions, etc.). Thus, the objectives of the present invention are to facilitate a mutually acceptable environment for all of the processing threads that are being executed within a processing system; this objective being subject to the respective processing requirements as required by mode-setting instructions that are specified by each executed processing thread.

Within embodiments of the present invention a bit vector is generated by a mode that is specified by a Set Mode (SM) instruction. In structure, this vector comprises a string of 1s, and 0s. In regard to the further explanation of this vector, the discussion will be restricted to a single particular bit within the vector. The discussion further applies to each other bit within the vector; wherein each bit can be managed independently.

In the event that a bit is a 1, this signifies that the particular hardware element or feature that is regulated by this bit must be activated in this mode. For example, if the bit corresponds to the floating-point unit, then an execution thread that is aware that it will utilize the floating-point unit must make take steps to ensure that the floating-point unit is activated. Therefore, this particular thread will issue a SM instruction specifying that the mode bit is on (i.e., set to 1).

In the event that the bit is a 0, this signifies that the thread does not need the particular feature that is regulated by this bit. That is, the corresponding hardware element can be deactivated, or in some instance left on; the action is not relevant to the particular thread. In a single-thread machine, this feature is turned off That is, since the 0 denotes that the hardware element is not needed, the hardware element would be turned off to save power or to accomplish another system optimization. Thus, in a single thread machine, 0 represents the directive to “turn off,” while in a multithreaded machine, 0 represents the directive that “an action is not necessitated.”

If any of the active threads require that a hardware element be activated/turned on (i.e., if any of the threads issued a SM with the corresponding bit set to 1), then the hardware element must be activated. Accordingly, the hardware element may only be deactivated/turned off if every thread has specified “an action is not necessitated” (i.e., if the most recent SM issued by every thread had this corresponding bit reset to 9). Therefore, in the simplest possible manner of conjoining the set of modes that has been specified, each mode bit that controls a feature is determined by the logical OR of the corresponding mode bits of the most recently issued SMs of every thread.

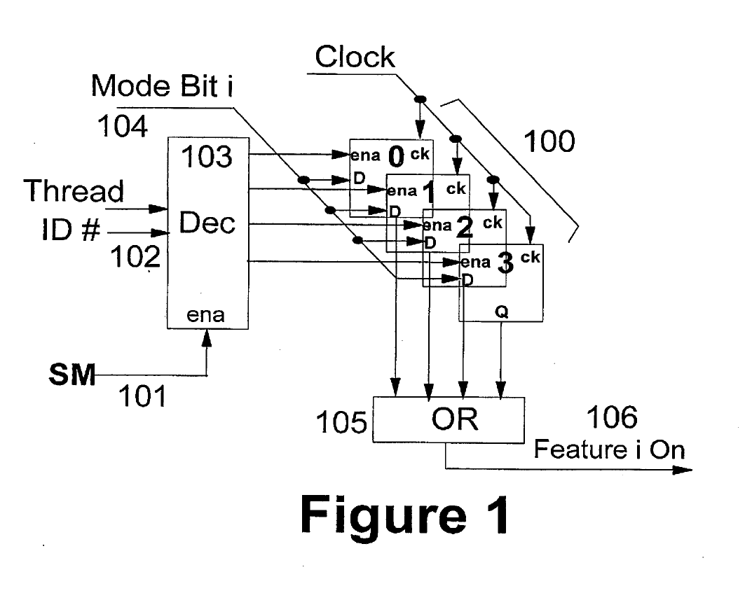

Turning now to the drawings in greater detail, it will be seen that in FIG. 1 there is an implementation of an embodiment for a single bit position in a 4-way multithreaded processor. For bit {i}, there are four mode latches 100, labeled 0, 1, 2, and 3; one latch is associated per thread, respectively. When a SM instruction is issued 101 by Thread ID inputs 102, the decoder circuit 103 enables the mode latch 100 corresponding to the Thread ID inputs 102 to be written with the newly asserted bit {i} 104. The OR circuit 105 actively maintains the OR of the most recently asserted values of bit {i} for all four threads, and it thereafter provides the control signal 106 to the corresponding hardware element for bit {i}. In function, the SM makes assertions about what must be on; therefore, the 0s in the mode vector are interpreted as “an action is not necessitated” instruction. A limitation of performing operations in this manner is that while the compiler will know what must be on for a particular section of code, it may not know what can be turned off.

What can be turned off will depend on how the program got to this section of code, and how soon it is going back to where it came from. In general, this cannot be statically determined, so the compiler will be forced to be overly conservative about what it is willing to state is a “an action is not necessitated” instruction. This is due in part because SM instructions generated in this modal operation will likely have more 1s in the mode vector than are really needed. Further, even to the extent that the compiler is able to determine what the “an action is not necessitated” instructions are, it determine on what the cumulative mode should be at any time; this means remembering what SM had been previously asserted.

Within aspects of further embodiments of the present invention two instructions, Set Mode On (SMON) and Set Mode Of (SMOFF) are required for asserting 1s and 0s, respectively. The SMON instruction asserts that all hardware elements that correspond to the 1s is in the mode vector be activated. The 0s in the mode vector are “an action is not necessitated” instruction. Unlike the SM instruction as described above, in this present embodiment the 0s in the mode vector will not be stored in the mode latches.

The 0s in the mode vector of the SMON instruction denote that the current state in the corresponding mode latch should be left alone. In this way, the compiler can make active assertions about what is knows must be turned on for a particular segment of code without having to remember (and in general, without being able to reconstruct) what it may have deliberately turned on in the recent past. In this way, the compiler need not be overly conservative about what it asserts should be on. It can give a purely localized assertion, and the mode latches will remember what had been asserted previously.

The complementary (dual) instruction is SMOFF, which does the analogous thing for turning features off. That is, the 0s in the mode vector of the SMOFF instruction actively assert that the corresponding hardware element be turned off for this particular thread. As in FIG. 1, the corresponding mode bits of all threads are combined in a logical OR, so no thread will be able to turn a hardware element off by itself. Instead, a 0 in the mode vector will reset the mode latch for the corresponding bit to 0 for the thread that issued the SMOFF instruction.

An indicator specified as a 1 in the mode vector of the SMOFF instruction corresponds to an “an action is not necessitated” instruction. Since this is the dual of a 0 in the mode vector of the SMON instruction, a 1 denotes that the state of the corresponding mode latch be left alone. In this way, the SMOFF instruction allows a compiler to actively assert what it knows can be turned off (assuming that the other concurrent executing threads allow the operation) without having to be able to construct and remember what had being going on globally.

In operation, the combination of the SMON and SMOFF instructions functional advantages. First, it is easier for a compiler to generate mode vectors for the SMON and SMOFF instructions, since these only require localized knowledge within a code segment; the mode latches will remember what had been going on before. Secondly, because only specific known changes are made to the state of the mode latches, we can be more aggressive about turning hardware elements off to save power (or to optimize other systematic features).

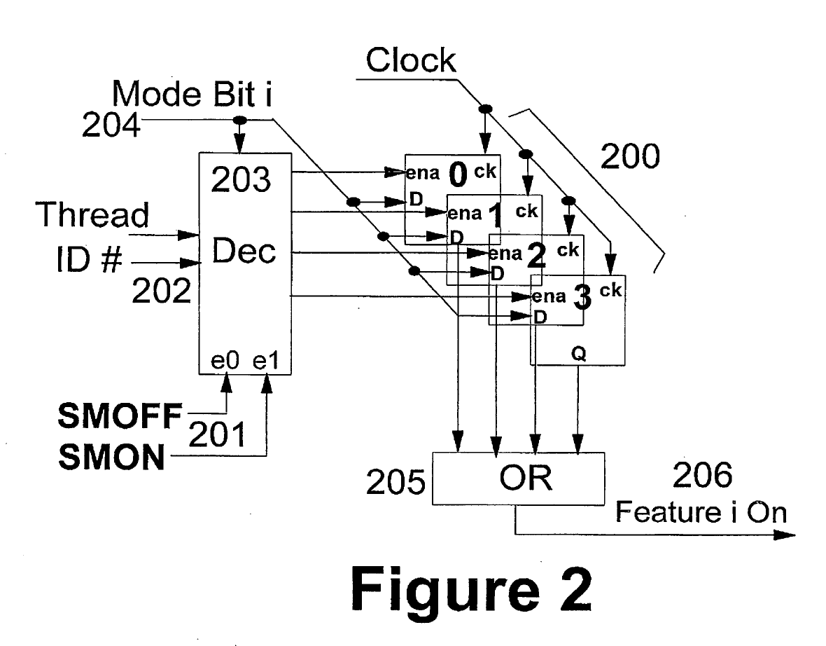

FIG. 2 shows aspects of one of many possible hardware embodiments for active mode assertions. Note that the diagram of FIG. 2 looks almost identical to FIG. 1. However, there are two substantial differences between the diagrams. Instead of the single SM input 101 to the decoder circuit 103 used in the implementation of FIG. 1, FIG. 2 features two inputs 201, SMOFFF and SMON, to decoder circuit 203. Additionally, the Mode Bit signal 204 (which is the appropriate bit of the mode vector) is now an input to the decoder circuit 203.

The job of decoder circuit 203 is to enable the mode latch of the selected thread (determined by the Thread ID inputs 202) to be written with a new value (which will be the Mode Bit 204) if the instruction is SMOFF and the Mode Bit 204 is 0, or if the instruction is SMON and the Mode Bit 204 is 1. Otherwise, selected the mode bit latch will not be enabled to receive the new data.

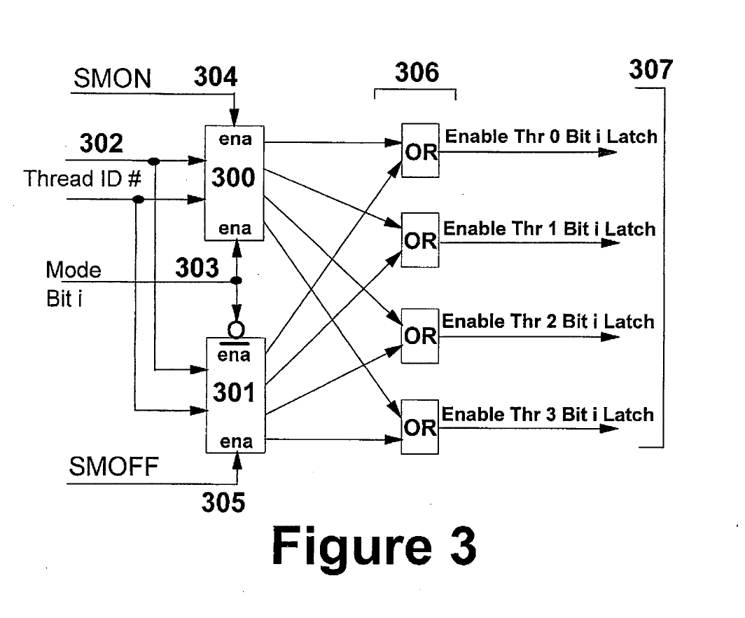

FIG. 3 shows a detailed view of a possible embodiment of the decoder circuit 203. The decoder circuit 203 comprises two decoder circuits 300 and 301 that are similar to the decoder circuit 103 of FIG. 1, except in this instance each of the two decoder circuits 300 and 301 have an additional enable input. Thus, the decoder circuit 300 is enabled only if there is a SMON instruction indication 304, and the Mode Bit 303 is a 1. When enabled, the decoder circuit 300 performs a straightforward decoding of the Thread ID input 302. Decoder circuit 301 is identical to decoder circuit 300, except that the enable input to which the Mode Bit 303 is connected is inverted (i.e., is enabled when the Mode Bit 303 is 0). The decoder circuit 301 is enabled only if there is a SMOFF instruction indication 305, and the Mode Bit 303 is a 0. When enabled, it does a straightforward decoding of the Thread ID 302. The OR circuits 306 combine the outputs of the two decoder circuits (300 and 301) to generate the individual enable bits for the mode latches of bit {i} 307.

Finally, note that at the conclusion of any thread, the compiler can choose to shut off all features by issuing a SMOFF with a mode vector containing all 0s. While this operation is acceptable, it must be noted that if a new thread is dispatched immediately thereafter, it must start by turning some of the features back on. If this happens, there will be no real energy savings, but there might be a current surge as a result of the activating and deactivating of a hardware element in rapid succession. There are two proposed solutions to this problem.

First, a new instruction, Set Mode Reset (SMR) can be implemented. A SMR is essentially a SMOFF instruction with an all 0 mode vector, except that it is delayed by a time interval. Note that to delay this, we will need a counter to time the delay operation. Since the mode vector is known to be all 0s, the SMR instruction need not explicitly provide the mode vector, since this is implicit in the opcode itself. Instead, the field that had been reserved for the mode vector can be used to hold a count value, so that the instruction itself can state what the delay is.

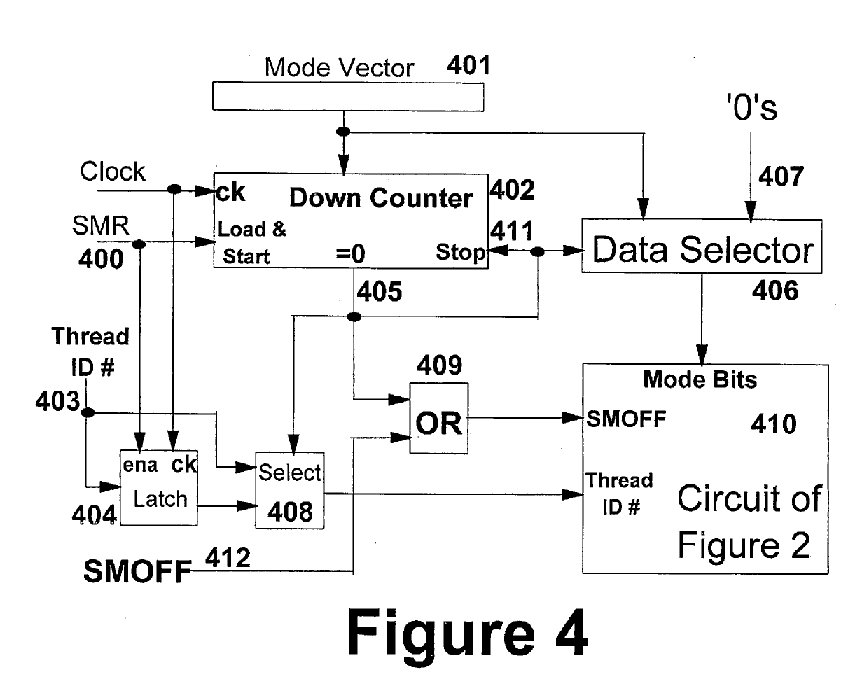

FIG. 4 shows one way in which this can be done. When the SMR instruction is issued 400, the mode vector field 401 of the instruction is not a mode vector, but is instead interpreted as a delay magnitude. This magnitude from the mode vector field 401 is loaded into a Down-Counter 402. At the same time, the Thread ID input 403 is captured in a latch 404. When the down counter reaches the value “0” (405), the Data Selector Circuit 406 chooses an “all 0” mode vector 407. Further, the Selector Circuit 408 chooses the value of the Thread ID input 403 that had previously been captured in the latch 404. Next, the OR Circuit 409 issues what appears to be a SMOFF instruction to the logic that is represented by 410. Concurrently, the Stop input 411 is applied to the Down Counter 402 so that the count stops on the next cycle, when the count will have rolled over to all 1s. When the count is not “0”, selectors 407 and 408, and OR circuit 409 allow the real-time mode vector 401, Thread ID input 403, and SMOFF signal 412 to feed through to the circuit 410.

In additional aspects of the present embodiment, it can be left up to an operating system to issue the SMOFF instruction with an all 0 mode vector when the operating system is sure that it is not about to dispatch another thread. This aspect can be accomplished in one of two ways. Either the operating system will need semantic ability to issue the instruction with an explicit thread ID, or the operating system can dispatch a new threat that merely issues the SMOFF instruction, and thereafter returns.

In yet further aspects of the present invention embodiments of the present invention can be regulated by the use of conditional mode assertion by the utilization of environmental conditions. So far, it has been assumed that the modes to be set are generally “knowable” at the time that they are issued. For example, whether or not a floating-point unit will be used, or whether or not we want to rapidly execute is knowable. More generally, there will be modes where it will be desirable to set, or not set, the modes based on environmental conditions that cannot be known at the time of compilation. For example, it may be desirable to throttle features of a hardware element back (or forwards) in the event that the temperature exceeds (or falls below) a particular value. This desirability may similarly be based upon other environmental conditions (e.g., noise, etc.).

Therefore, within aspects of the present invention it is possible to assert modes conditionally, wherein the mode condition is a parameter that must be readable at the time that an assertion is made, but that can't be known ahead of time. This aspect can be accomplished by implementing an instruction, Sense Environmental (SE), wherein the SE instruction is configured to read all of the environmental parameters that have been established; and thereafter, return the parameters in a vector. Subsequently, the operating system can determine what the states of the environmental conditions are, and thusly, can issue the appropriate SM, SMON or SMOFF instructions as previously described.

Yet further conditional instructions can be established. Set Mode Conditionally (SMC), Set Mode ON Conditionally (SMONC), and Set Mode OFF Conditionally (SMOFFC) instructions can be implemented, wherein these instructions comprise the same features of the SM, SMON, and SMOFF instructions as described above, except that in this instance the mode vectors are replaced by vectors of conditions. Therefore, the semantics of any of these would be {<opcode>, <conditional mode>}, where <opcode> is one of {SMC, SMONC, SMOFFC}, and <mode> is a vector (<C1>, <C2>, <Cn>) of conditions, each of which controls a feature. As mentioned above, the vector of conditions can either be stated explicitly in the instruction, or the instruction can provide the method for constructing the vector (e.g., it could be fetched from an address in memory or from a register).

In operation, the conditions (<C1>, <C2>, . . . , <Cn> correspond to the previously described mode bits, but in general, a condition <Ci> will be specified by more than one bit. The meaning of an instruction such as SMON (<C1>, <C2>, . . . <Cn>) is: activate hardware element 1 if <C1> is true, activate hardware element 2 if <C2> is true, etc.

Some of the modes that depend on environmental parameters can be disjoint from the other modes. That is, there can exist an ISA that contains both of the instructions SM and SMC, but the mode vector of the SM instruction may pertain to a different set of features than the conditional mode vector of the SMC instructions. There may also be features that can be modulated by either instruction.

Also, it must be noted that environmental conditions that are relevant to one hardware element may not be the same set of environmental conditions that are relevant to another hardware. Therefore, each field <C1> can be tailored to pertain to those parameters that are relevant to feature {i}. Thus, even if the numerical values of two conditions, {C1} and {Cj}, are the same, they may be specifying different environmental conditions. Additionally, different features may be conditioned on different numbers of environmental parameters, so in general, the number of bits in {Ci} may not be the same as the number of bits in {Cj}.

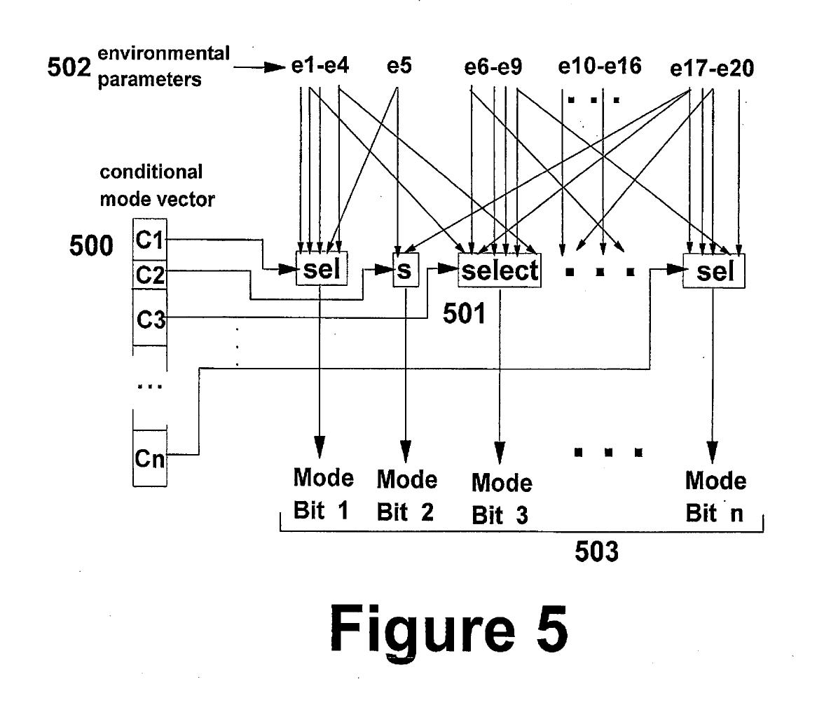

The operation of a SMC is identical to the operation of a SM (as is the operation of a SMONC and a SMON, and the operation of a SMOFFC and a SMOFF), with the exception of how the mode bits are constructed. Therefore, the circuits illustrated in FIGS. 1 and 2 remain the same when the modes are conditional. It is merely the construction of the mode bits that changes. In the previous embodiments, the mode bits were taken directly from the mode vector. When the modes are conditional, they must be constructed in the manner as illustrated in FIG. 5.

In FIG. 5, the Conditional Mode Vector 500 (either taken directly from the instruction, or constructed in a manner specified by the instruction), is shown to comprise in conditions, C1, C2, . . . Cn, each of which will specify how their respective mode bits are generated. The fields C1, C2, . . . Cn specify selections to the data selectors 501. The data inputs to the data selectors 501 are taken form a set of available environmental parameters 502 (for illustrative purposes only, twenty (20) environmental parameters are shown). The selection fields {<ci>} select the appropriate environmental parameters {ci} (which are either true or not) as the final Mode Bits 503. These mode bits are then operationally utilizes as previously described in relation to the objectives set forth above in relation to FIGS. 1 and 2.

Within additional aspects of the present invention, the environmental parameters can be a constant, i.e., we can hardwire any input to a 1 or a 0. This will provide a method for unconditionally turning a feature on or off when issuing a conditional mode-setting instruction.

The capabilities of the present invention can be implemented in software, firmware, hardware or some combination thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for supporting simultaneous multithreading within a computing environment, wherein the method further comprises the steps of:
identifying at least two programs, where in the programs are executed as respective processing threads;
generating a Set Mode instruction, the Set Mode instruction being configured to be executed within at least one processing thread, the Set Mode instruction further comprising a mode field, the mode field identifying at least one system resource that is configured to be activated or deactivated, wherein the step of generating a Set Mode instruction further comprises the steps of:
generating a Set Mode instruction, wherein the mode field of the Set Mode is set to ON in the event that a compiler logic mechanism determines that this action is required by an executing code segment in regard to the system resource that is associated with the mode field, and
setting the mode field of the Set Mode to Off in the event that the compiler logic mechanism determines that there is no action required by the executing code segment in regard to the system resource that is associated with the mode field; and
transmitting a control signal to activate or deactivate the at least one system resource, the control signal being based on a logical combination of mode fields that are set by Set Mode instructions comprised within the programs that are executed as respective processing threads.

2. The method of claim 1, wherein the step of generating a Set Mode instruction comprises generating a Set Mode Conditionally instruction, the Set Mode Conditionally instruction comprising a mode field wherein the mode field identifies at least one condition that is to be evaluated for the at least one system resource.

3. A method for supporting simultaneous multithreading withn a computing environment, wherein the method further comprises the steps of:
identifying at least two programs, wherein the programs are executed as respective processing threads;
generating a Set Mode instruction, the Set Mode instruction comprising a mode field, the mode field identifying at least one system resource that is capable of being activated or deactivated, the Set Mode instruction being further configured to comprise a Set Mode On (SMON) instruction or a Set Mode Off (SMOFF) instruction that is executable within each respective processing thread, the step of generating a Set Mode instruction further comprising the steps of:
generating SMON and SMOFF instructions, the step of generating SMON and SMOFF instructions further comprising the steps of:
generating a SMON instruction setting a first mode field to On in the event that a compiler logic mechanism determines a positive requirement is required by an executing code segment in regard to the system resource that is associated with the first mode field, and setting the first mode field to Off in the event that the complier logic mechanism determines that no positive requirement is required by the executing code segment in regard to the system resource that is associated with the field mode field;
generating a SMOFF instruction setting a second mode field On in the event that the compiler logic mechanism determines that no positive requirement is required by the executing code segment in regard to the system resource that is associated with the second mode field, and setting the second mode field Off in the event that the compiler logic mechanism determines a positive requirement is required by the executing code segment in regard to the system resource that is associated with the second mode field; and
transmitting a control signal to active or deactivate the at least one of system resource based on a logical combination of mode fields set by SMON and SMOFF instructions within programs executing within the respective processing threads.

4. The method of claim 3, further comprising the step of generating a Set Mode Reset instruction, the Set Mode Reset instruction comprising a time delay interval field that specifies a time delay interval that must expire before setting a field mode that is configured to be ON to an Off configuration by the SMOFF instruction.

5. The method of claim 3, wherein the step of generating a Set Mode instruction comprise generating a Set Mode On Conditionally instruction or a Set Mode Off Conditionally instruction, further, the mode field associated with each conditional instruction identifies at least one condition that is to be evaluated for the at least one system resource.
